(19) United States
(12) Patent Application Publication
(10) Pub. No.: US 2009/0040045 A1
(43) Pub. Date: Feb. 12, 2009

(54) System and Method for Monitoring Manufactured Pre-Prepared Meals

(76) Inventors: Hubert Eric Walter, Ulm (DE); Karl-Heinz Haas, Achtstetten (DE); Roland Jans, Ulm (DE)

Correspondence Address: FAY KAPLUN & MARCIN, LLP, 150 BROADWAY, SUITE 702, NEW YORK, NY, 10038, US

(21) Appl. No.: 11/910,696

(22) PCT Filed: Apr. 6, 2006
(86) PCT No.: PCT/DE2006/000650

§ 371 Date: Jun. 3, 2008

(30) Foreign Application Priority Data
Apr. 7, 2005 (DE) 102005016700.4

(51) Int. Cl. G08B 21/00; H04Q 5/22

(52) U.S. Cl. 340/540; 340/10.1

(57) ABSTRACT

Described are a system and a method for monitoring pre-prepared meals which can be assembled as a plurality of portions. Assembled pre-prepared meals can be monitored starting from their assembly up to the ultimate consumption. Pre-prepared meals are arranged on tray-like containers and a data carrier is fastened which contains meal-specific data. These meal-specific data can be read out at least two reading stations to be able to keep a record of the conditions of manufacture, storage and/or cooling.

The invention relates to a system and to a method for monitoring pre-prepared meals which can be assembled as a plurality of portions.

In this context, the assembly takes place by means of tray-like containers (shelves) in which containers containing pre-prepared meals can be arranged in a locally defined manner and, where possible, can also be fixed against sliding by a corresponding design of the respective tray-like containers, which can be achieved by corresponding receivers for containers with meals on tray-like containers. However, similar containers can also be used, for example those which can also be closed by covers. A wireless and contactless transmission of information from, and optionally also to, data carriers should, however, remain ensured in this context. Further goods from the catering sector can also be present in addition to meals and beverages.

Such a tray-like member element can be equipped solely for the assembly with containers containing meals which subsequently have to be heated before consumption. However, there is also the possibility to position containers with meals which can also be consumed cold on tray-like containers and, optionally, to include other articles or also beverages in such a tray-like container.

The assembly of the different meals and, optionally, also beverages usually takes place in centralized fashion at one position and subsequently a storage takes place and a transport, via a transport chain which can also be interrupted, up to the consumer.

Use is in particular provided for the provision of foodstuffs and beverages for consumption in means of transportation, very specifically preferably in aircraft.

However, problems occur in the known solutions since it is not possible, or is only insufficiently possible to achieve a record of the observation of a cold chain, the respective best-before date by which the meals may be consumed and also a record on the supply of the assembly from the caterer to the consumer.

Incorrect deliveries can thereby not be recognized or only recognized with an increased effort.

The observation of a set cold chain is moreover not possible and there is moreover the risk that meals correspondingly assembled in this way will be consumed after the expiry of their shelf life and an impairment of the health of corresponding consumers can thus occur.

It is therefore the object of the invention to provide a system with which correspondingly assembled pre-prepared meals can be monitored starting from their assembly up to the ultimate consumption.

In accordance with the invention, this object is solved by a system having the features of claim 1. A method having the features of claim 17 can be used in this context.

Advantageous aspects and further developments of the invention can be achieved using features designated in the subordinate claims.

For this purpose, a data carrier should be attached to a tray-like container. In this connection, such a data carrier can be attached directly to the tray-like container, but also to at least one container for meals or beverages which is in turn received and held by means of a tray-shaped container. Similarly designed containers, for example box-shaped, can also be used.

Such a data carrier should be suitable to be able to read out the respective data.

The data should be able to be read out at least one reading station, preferably two reading stations. The reading stations can also be designed such that in addition a transmission of data to the data carrier, that is a reading or a writing of data, is possible.

The data stored on the data carrier can be the respective date of manufacture, assembly and/or of maximum shelf life. In addition, data on the quantity, mass or number can also be utilized. The maximum shelf life date should, however, mean the shelf life date of a meal or also of a beverage on a tray-like container having the shortest shelf life period.

Those data carriers are preferred which can store the corresponding data in electronic form and which can be read out in contactless manner by means of electromagnetic waves, which is e.g. possible with RFID technology known per se. In this case, a semiconductor circuit member with an antenna on a carrier suitable for the transmission of data is suitable. The reading out can take place over a distance of some centimeters up to several meters using suitable systems which likewise have an antenna. The transmission of the data takes place substantially inductively and/or capacitively, with the possibility also being able to be given in this case of subsequently storing corresponding data on such a data carrier.

This is e.g. advantageous when corresponding recording data should be stored during transportation and storage.

Corresponding data on the entry into a storage depot, a cooling depot, the placing into a meal trolley can thus be stored.

This relates to the respective location and in the case of a cooling the respective times and storage temperatures can additionally be input. Data can be temporarily stored at the respective locations at which a reading of data from data carriers takes place and can subsequently or, optionally, simultaneously or in real time or almost real time be transmitted to a central data processing unit with which a monitoring of the respective logistics takes place.

For an uninterrupted monitoring of a set cooling chain to be observed, an additional temperature sensor can be used with the data carrier which transmits corresponding measured temperature signals to the data carrier as additional information continuously or also sequentially in specific settable time cycles. In this case, an additional element for the storage of electrical energy should be present which can advantageously be charged again or also rechargeable, with such charge procedures of such an electrical energy storage element being able to take place, where possible, in a wireless and contactless fashion in an inductive or capacitive manner.

Furthermore, other characteristic additional data can also be stored on a data carrier which can be utilized for the control of a unit for heating on the heating of corresponding meals. For example, different meals thus correspondingly require different heating conditions, which substantially relates to the respective temperatures, heating rates and the maximum heating time. In addition, data can be stored in the data carrier which reproduce the respective position of meals to be heated and of meals or beverages not to be heated on a tray-like container so that when an assembled tray-like container is introduced into an oven unit in which an inductive heating is preferably to be carried out, the heating then only takes place locally specifically at locations at which meals to be heated are positioned.

Furthermore, at least one reading unit for corresponding data should also be present at such a unit/oven for the heating of meals and is then connected to the control of this unit/oven.

A possibility should advantageously be provided with which a warning signal is generated on a read-out of data which may occur, said data signaling the expiry of a maximum shelf life of meals or beverages and said warning signal then displaying this data visually and/or acoustically and warning the operator. A datum recognized in this matter can, however, also be evaluated in this manner and transmitted to the control of the unit/oven so that no heating of meals can take place in such a unit/oven after the expiry of the shelf life and a health risk can be prevented with almost 100% security.

The already mentioned reading and/or transmitting units for data of the data carriers can be arranged at respective gates through which the assembled meals and beverages can be introduced to and removed from storage and transportation units. This relates to gates or supply entrances of storage and cooling depots. Corresponding reading and transmitting units for the data can also be present on means of transportation such as trucks or rail vehicles on the respective doors or gates. The electrical energy supply for the reading and/or transmitting units is possible without problem at such locations as a rule.

With mobile meal trolleys such as are frequently used in aircraft, however, corresponding reading and/or transmitting units for data should likewise preferably be attached in the region or proximity of doors. Such meal trolleys usually do not have their own electrical energy storage or connections for electrical energy. The latter are also frequently unfavorable since an electrical energy supply via leads is unfavorable in the utilization of meal transportation means.

Electrical energy storage elements can therefore be attached to the meal trolleys which can be charged inductively and/or capacitively, which is possible at corresponding charging stations. For this purpose, the meal trolleys only have to be positioned accordingly so that a contactless electrical energy transmission can take place inductively and/or capacitively on a correspondingly designed electrical energy store. Corresponding charge stations can be present at specific central points, also inside means of transportation, e.g. aircraft, so that a corresponding meal trolley only has to be positioned at a sufficient distance from such a charge station. It can then be used in a mobile manner with a charged electrical energy store.

An additional, readable intermediate store for data can be present on a meal trolley equipped in this manner and its intermediately stored data can be read out via optionally present connections and transmitted, as already discussed above, to a central data processing unit. The read-out of data of such an intermediate store can likewise take place in a wireless manner via RFID technology.

Correspondingly suitable possibilities for the formation of corresponding antennas, data stores and electrical energy stores can also be retrofitted to meal trolleys. Coils can thus be installed at the housing of meal trolleys, for example, with corresponding joints preferably being cut out into which the individual windings of coils can be laid.

Such antennas should be present on the outer walls or also on all doors of meal trolleys since they can as a rule be applied on both sides and a removal is also possible from both sides.

Electronic display elements (displays) can also be installed at meal trolleys so that data on the contents can be obtained easily from the outside. The respectively displayed data can also be directly selected in this context, which is e.g. possible via an electronic unit with an input option via a keyboard or by means of touch screen technology. The respective destination can thus be visibly displayed from the outside on a corresponding selection. Display elements can be used which are also able to continue to display the data without a further connection or after a deactivation of electrical energy.

Receiving and transmitting elements such as already discussed above can, however, also be present in storage containers inside kitchens (galleys). The aforesaid statements on a possible intermediate storage and transmission of corresponding data to a central data processing unit also apply here. An almost uninterrupted recording of the storage and transportation up to consumption can thus be made via the locally detected and read out data, with a record of the observation of a cooling chain also being possible in a preferred embodiment.

In addition, the corresponding identification data for the respective meal trolley can also be stored on meal trolleys so that there is at least a record with which the last detected location of the respective meal trolley is possible. The system in accordance with the invention moreover simplifies the effort for inventories and for accounting, with the latter also applying to specific articles which do not necessarily have to be meals or beverages, but also articles sold inside means of transportation, for example duty free articles.

The system in accordance with the invention can not only be advantageously used for the catering for passengers in means of transportation, but also in other areas such as is the case in clinics or in large catering companies.

A complex monitoring of the most varied elements used, such as the assembled containers and meal trolleys with contents and respective location can take place with systems in accordance with the invention, with the latter applying at least to the location at which corresponding data were last read out from data carriers. In this context, the content data can also be utilized to obtain and process findings on the respective contents electronically, that is without any additional written documentation. This e.g. relates to the reordering or also to the accounting of used or sold articles so that differences can be avoided in accounting or also in inventories and the administration effort can be reduced.

If such data are read out in a mobile means of transportation such as a rail vehicle or an aircraft, they can also be transmitted in a wireless manner by means of transmitting and receiving systems known per se, for example as GMS or UMTS signals, and can be supplied to a central data processing unit so that a real-time monitoring and control is thereby also possible.

With meals and beverages, an electronic detection, further processing and evaluation of HACCP data according to ISO 9000 can take place with the system in accordance with the invention so that paperless work is possible.

A storage and evaluation of detected information from data carriers can naturally not only take place at the central data processing unit already mentioned a plurality of time, but also at interposed data processing units alone or additionally.

The corresponding antennas or receivers for the detection of data transmitted wirelessly can be designed at the stations for the reading of data from the respective data carriers transmitted by means of electromagnetic waves, e.g. using RFID technology, such that the data carriers can be moved through the respective windings of corresponding coils and such that at least the reading out of data can be achieved, but preferably also the transmission of additional new information.

These data carriers, which can be operated in RFID technology, can, for example, be so-called “smart labels” in label form which can be fastened to the pre-assembled tray-like container relatively simply via an adhesive film. Operation can take place at a standardized transmission frequency for data, for example 13.56 MHz.

Specific data can then be stored at the place of assembly, which in particular applies to the identification data for an assembled tray-like or similarly made container.

Such a data carrier can be attached to the tray-like container at a protected location so that it is protected as much as possible from mechanical damage. The fastening of such data carriers, and also the writing of the respective data, can take place in automated fashion so that the costs can also hereby be reduced and errors prevented.

A plurality of antennas for the transmission of data can be present at reading and/or transmitting units for data and preferably realize the data transmission and storage via multiplexes. In this context, the antennas can also be configured for the different frequencies which are used for the transmission of data from and also to data carriers so that the different transmission systems can be taken into account.

1-28. (canceled)

29. A system for monitoring at least one of pre-prepared meals and beverages arranged on a tray-like container, comprising:
a data carrier fastened to the container, the data carrier storing meal-specific data, the data related to the at least one of the meals and the beverages;
at least one reading station at least one of reading and transmitting the data to the data carrier; and
a reading unit reading the data from the data carrier, the reading unit being disposed on a heating unit that heats the at least one of the meals and the beverages based on the data.

30. The system of claim 29, wherein the data includes at least one of manufacture, storage, cooling, and transportation parameters.

31. The system of claim 29, wherein the at least one reading station one of reads and transmits the data and the reading unit reads the data from the data carrier in a contactless manner using electromagnetic waves.

32. The system of claim 29, wherein the at least one reading station one of reads and transmits the data and the reading unit reads the data from the data carrier using an RFID technology.

33. The system of claim 29, wherein the data carrier is fastened directly to the tray-like container.

34. The system of claim 29, wherein the data carrier is fastened directly to at least one of a meals container and a beverages container, the meals container and the beverages container being received by the tray-like container.

35. The system of claim 29, further comprising:
a temperature sensor transmitting measured temperature signals to the data carrier.

36. The system of claim 29, further comprising:
an element storing an electrical energy.

37. The system of claim 36, wherein the element is charged in a wireless and contactless manner.

38. The system of claim 29, wherein at least one of the at least one reading station and the reading unit are attached in a region of a door of a meal trolley.

39. The system of claim 38, further comprising:
elements storing electrical energy which are at least one of inductively and capacitively charged, the elements being attached to the meal trolley.

40. The system of claim 38, further comprising:
antennas installed at least one of in a housing and on the housing of the meal trolley.

41. The system of claim 40, wherein the antennas are disposed in joints of the housing.

42. The system of claim 290, further comprising:
an intermediate storage unit reading the data, the intermediate storage unit being disposed on the meal trolley.

43. The system of claim 42, further comprising:
electronic display elements visually displaying the data of at least one of the data carrier and the intermediate storage.

44. The system of claim 29, further comprising:
a plurality of antennas transmitting the data, the antennas being coupled to the at least one reading station and the reading unit.

45. A method for monitoring at least one of pre-prepared meals and beverages arranged on a tray-like container, comprising:
storing meal-specific data on a data carrier, the data carrier receiving the data in a contactless manner, the data relating to the pre-pared meals;
reading the data with at least one reading unit, the at least one reading unit being situated on a heating unit that heats the at least one of meals and beverages;
controlling the heating unit based on the data.

46. The method of claim 45, wherein the data includes at least one of manufacture, storage, cooling, and transportation parameters.

47. The method of claim 45, wherein the data is stored during a transportation and a storage.

48. The method of claim 45, wherein the contactless manner is wireless.

49. The method of claim 45, wherein the storing further includes storing temperature signals in the data, the temperature signals including temperate data measured during a transportation and a storage.

50. The method of claim 45, further comprising:
generating a warning signal when a maximum shelf life of one of the meals and the beverages expires.

51. The method of claim 45, wherein the heating is only carried out in a controlled manner with respect of locally specifically locations at which at least one of the meals and the beverages to be heated are positioned.

52. The method of claim 45, further comprising:
wirelessly transmitting the data to a central data processing unit.

53. The method of claim 45, further comprising:
transmitting the data at least one of to the data carrier and from the data carrier in one of an inductive manner and a capacitive manner.

54. The method of claim 45, further comprising:
displaying the data on electronic display elements of a meal trolley that holds the tray-like containers.

55. The method of claim 54, further comprising:
before the displaying step, selecting display data to be displayed from the data.

56. The method of claim 54, further comprising:
deactivating the heating unit; and
displaying the data.

57. The method of claim 45, wherein the data is at least one of received and read using a plurality of antennas.
